(19) United States
(12) Patent Application Publication
(10) Pub. No.: US 2016/0042370 A1
(43) Pub. Date: Feb. 11, 2016

(54) PROVIDING SURVEY CONTENT RECOMMENDATIONS

(71) Applicant: SURVEYMONKEY INC., PALO ALTO, CA (US)

(72) Inventors: PHILLIP JOHN LUDWIG, SAN FRANCISCO, CA (US); TIMOTHY GRAY CEDERMAN-HAYSOM, SAN CARLOS, CA (US); JAMES ALEXANDER LEVY, PALO ALTO, CA (US); SHAYANI ROY, MOUNTAIN VIEW, CA (US); BRETT LEONARD SILVERMAN, SAN FRANCISCO, CA (US); FEDOR NIKITOVICH DZEGILENKO, SAN JOSE, CA (US)

(21) Appl. No.: 14/452,336

(22) Filed: Aug. 5, 2014

(51) Int. Cl. G06Q 30/02; G06F 3/0482; G06F 3/0484

(52) U.S. Cl. CPC G06Q 30/0203; G06F 3/04842; G06F 3/0482

(57) ABSTRACT

A computer-controlled method of recommending survey content to a user includes receiving an input from a user through a user interface that initiates creation of a survey, accessing information about the user, retrieving pre-existing content from a content repository based upon the information, and presenting the pre-existing content to the user.

### BACKGROUND

Surveys allow people, organizations, and companies to gather valuable information from customers, participants, employees, etc. The survey creators can use this information to improve their products and services, adjust their operations, strategically plan for their business, etc. Putting surveys online provides an easy forum for survey creators to reach their audiences.

However, survey creators have to develop their questions, templates, etc., sort out what topics they want to cover, organize the questions, etc. This can dissuade many potential users from performing surveys, preventing them from gathering valuable information.

### BRIEF DESCRIPTION OF THE DRAWINGS

FIG. 1 shows an embodiment of a networked system.

FIG. 2 shows an embodiment of an electronic device.

FIG. 3 shows a portion of an embodiment of a method of providing survey content recommendations to a user.

FIG. 4 shows a portion of an embodiment of a method of providing survey content recommendations to a user.

FIG. 5 shows an embodiment of a portion of a user interface for recommending survey content.

FIG. 6 shows an embodiment of a portion of a user interface for recommending survey questions.

### DETAILED DESCRIPTION OF THE EMBODIMENTS

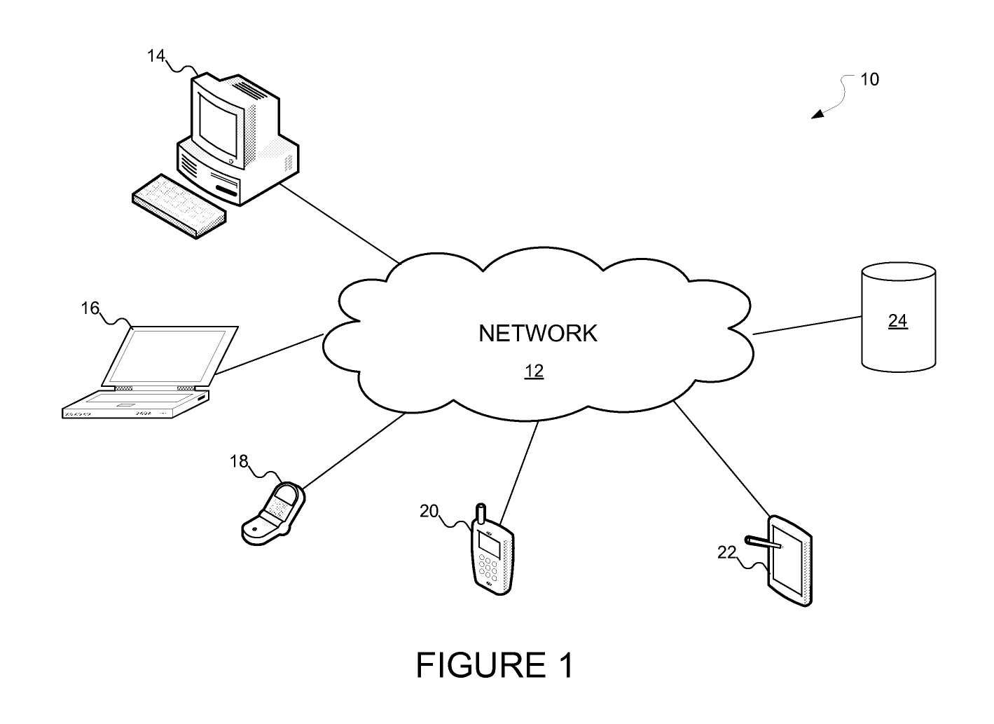

FIG. 1 shows an example of a networked system 100. In this example, the system 100 includes a network 102 such as the Internet, an intranet, a home network, a public network, or any other network suitable for implementing embodiments of the disclosed technology. In the embodiment here, personal computers 104 and 106 may connect to the network 102 to communicate with each other or with other devices connected to the network.

The system 100 may also include one or more mobile electronic devices 108-112. Two of the mobile electronic devices 108 and 110 are communications devices such as cellular telephones or smartphones. Another of the mobile devices 112 is a handheld computing device such as a personal digital assistant (PDA), tablet device, or other portable device. A storage device 114 may store some of all of the data that is accessed or otherwise used by any or all of the computers 104 and 106 and mobile electronic devices 108-112. The storage device 114 may be local or remote with regard to any or all of the computers 104 and 106 and mobile electronic devices 108-112.

The storage device may consist of a repository of pre-existing content. While the main use may be to select questions for a survey, other types of content may be used as well such as templates, etc. For ease of understanding, the discussion will focus on questions as an example of pre-existing content, but no limitation to questions is intended nor should it be inferred. Similarly, the discussion may refer to the repository of pre-existing content as the Question Bank, it is not limited to pre-existing questions.

The questions may have identifiable characteristics that allow them to be categorized according to such things as topic, categories, etc. In one embodiment, the questions may have different portions, such as a semantic portion, a superficial portion and an open-ended portion. The questions may consist of these portions as set out in U.S. patent application Ser. No. 13/966,829, the entirety of which is incorporated by reference herein. Regardless of the exact nature of the characteristics, the characteristics can be used to make recommendations for the user based upon information about the user.

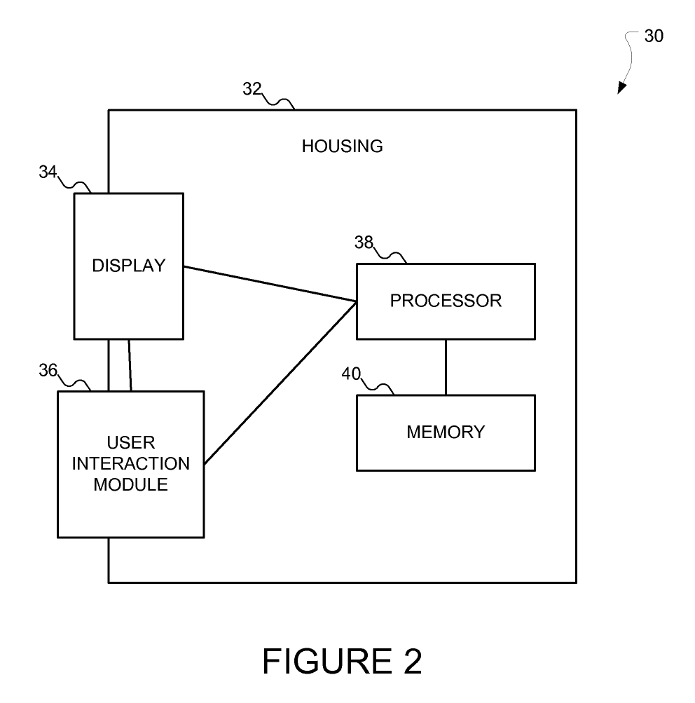

FIG. 2 illustrates an example of an electronic device 200, such as the devices 104-112 of the networked system 100 of FIG. 1, in which certain aspects of various embodiments discussed here. The electronic device 200 may include, but is not limited to, a personal computing device such as a desktop or laptop computer, a mobile electronic device such as a PDA or tablet computing device, a mobile communications device such as a smartphone, an industry-specific machine such as a self-service kiosk or automated teller machine (ATM), or any other electronic device suitable for use in connection with certain embodiments of the disclosed technology.

In the example, the electronic device 200 includes a housing 202, a display 204 in association with the housing 202, a user interaction module 206 in association with the housing 202, a processor 208, and a memory 210. The user interaction module 206 may include a physical device, such as a keyboard, mouse, microphone, speaking, or any combination thereof, or a virtual device, such as a virtual keypad implemented within a touchscreen. The processor 208 may perform any of a number of various operations. The memory 210 may store information used by or resulting from processing performed by the processor 208.

The various components may be used in a survey system to allow a user to create a survey, where the system provides recommendations to the user for the user's survey. The system may include a repository of questions, a first computer that provides a user interface to the user allow the user access to survey creation tools. The system may also include a second computer upon which the survey tools reside. The repository and the second computer may be the same computer. The first computer may be a mobile or other user device.

The system allows the user to create surveys. The survey accesses the survey provider's website or other computer upon which the survey tools reside to create a survey. The creation of the survey may occur with or without user-provided information. User-provided information consists of any information volunteered by the user. This information may take the form of a user profile, a survey category designated by the user, etc. Alternatively, the user may not volunteer information. However, the system can determine some of the information from the user's interaction with the system. For example, the system can determine the location from where the user accessed the site. Other types of information may also be available, such as the type of device, etc., but may not contribute much to the usefulness of the recommendations made by the system.

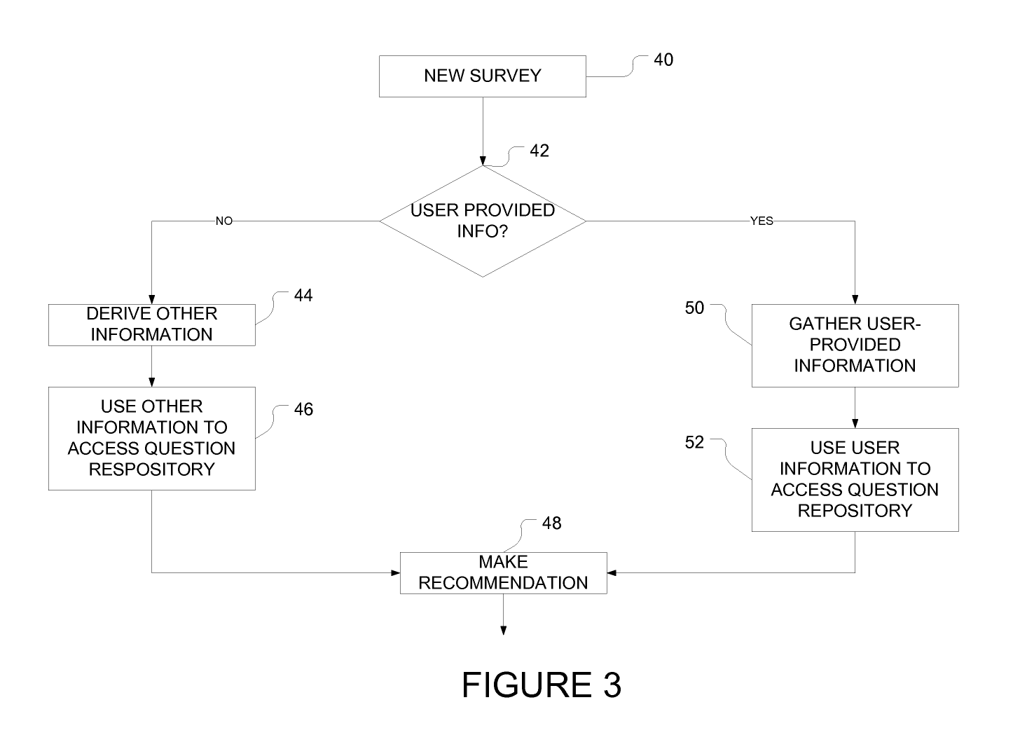

FIG. 3 shows a flowchart of a portion of an embodiment of a method to provide question recommendations with user provided information. The user accesses the survey site at 40 and begins creating a new survey. The system checks to see if there is user provided information at 42. User provided information may include a user profile, a user selected survey category, etc. If this information is available, the user-provided information is gathered at 50. This may consist of merely accessing previously provided information or may entail prompting a user to designate a survey category, fill out a profile, or to provide some other type of information.

If there is no user-provided information at 42 and the user has moved directly to writing or selecting questions, the system has no information to use to make question recommendations. The system then has to derive some user information. The system may derive some information from the user's log in such as the user's location. The user's location may not be any more specific than the country, which would then provide the language for question recommendations. The information may include information about from where the user came, such as how the user reached the site, through search engine optimization or search engine marketing. The user information may include browser information, and operating system information. The information may also be an combination of these things.

In either case, the information gathered is used to access the question repository and to identify question recommendations. For user-provided information, information is used to access the question repository at 52. For the system-derived information, it is used to access the question repository at 46. The recommendation is made at 48.

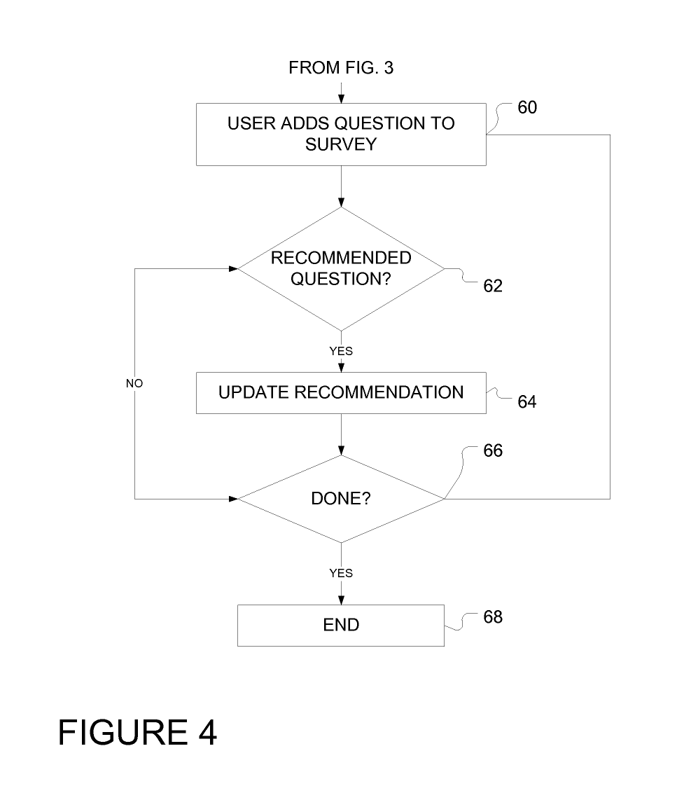

FIG. 4 shows a flowchart of a portion of an embodiment of a method to provide question recommendations without user provided information. Once the recommendation is made, the user adds a question to the survey at 60. The user may pick one without using the recommendation, one from an expert template provided by the survey provider, and or may write the question without either. If the user uses a recommended question at 62, that selection can be used to improve the next recommendation. The recommendations are then updated at 64. If the user does not use the question, the process then determines if the user has finished creating the survey. If the user is not done, the process returns to where the user adds a question to the survey at 60. If the user is done, the process ends at 68.

In one example, the user-provided information consists of a type of survey the user is interested in creating. In this example, the types of surveys are pre-created such as Events, Customer Feedback, Education, Healthcare, etc. There may be sub-categories within the pre-created types, such as “RSVP and Contact Info” within the Events category. The questions in the Question Bank are sorted into similar categories. There may be categories within the Question Bank that are not included in the profile options. Question Bank is much more granular where individual questions exist in sub-categories of the higher level categories. Usage data from use of the Question Bank can be used to determine patterns such as most popular within different categories and sub-categories, which questions are most commonly edited, if a user adds a particular question what other questions are users most likely to add in the same survey.

In this example, if the user picks a profile category and that is the only information the system has about that user, the system recommends the most popular Question Bank questions that were added from that specific top-level category. If the user picks a profile category and then a survey category that is different, the system recommends the most popular Question Bank questions that were added from that specific top-level category. If the user adds a question from the Question Bank while creating a survey, the system uses the patterns established to recommend other questions that the user is most likely to add to the survey. The system can then use a combination of seeds to determine patterns from the data and suggest smarter questions from Question Bank. This system is self-correcting and self-learning. As more people use the Question Bank and the profiling capability, more usage data and behavior data is available. This allows the system to create patterns that make the engine smarter.

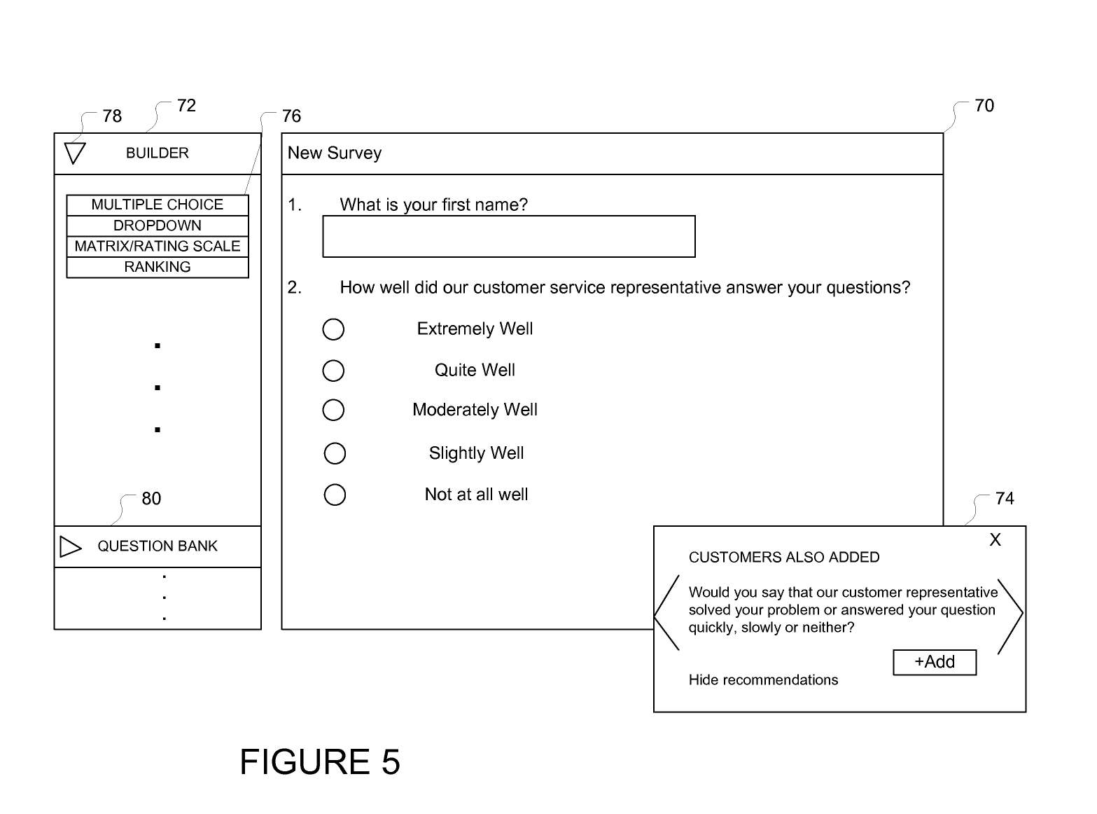

The recommendations made can take many forms. An embodiment of a user interface for creating a survey, the interface including recommendations, is shown in FIG. 5. The user interface in this example has 3 different parts. The main window 70 has the survey questions being written. The side window 72 lists questions by format. The bottom window 74 has the recommendations made based upon the question picked. Of course, other formats for providing the recommendations are possible, as are other formats of the windows, template, etc.

In the embodiment shown, the side window 72 has several options available to the user, each shown in collapsible/expandable format. For example, the topic “Builder” has been expanded using the button 78 to show the user various question formats as sub-topics 76. One of these options is Question Bank.

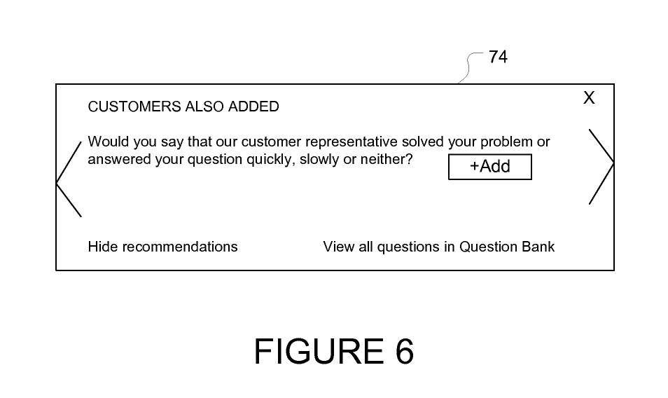

The pop-up window 74 with the recommendations has several options. The user may be given arrows to move through the recommendations. The user can add questions to the survey being created by activating the “Add” button. The user can also hide the recommendations. If the user adds a question from the Question Bank from the recommendation window, in addition to changing the next recommendation based upon the new information, the pop-up window 74 may change as shown in FIG. 6.

If the user selects a pre-determined number of Question Bank questions while creating the survey, the system may offer the user access to see all questions in Question Bank. As shown in FIG. 6, the user now has the option of selecting to see all questions in the Question Bank. This is merely one embodiment of a possible change to the pop-up window. Another option may include showing all of the questions within a particular category of the Question Bank.

In this manner, the survey creator can provide recommendations for questions to users who are building surveys. The system may pick recommendations based upon information provided by the user or may do so based upon information the system derives from the user. Once the user selects a question from the recommendations, that information is used to further tailor the recommendations. In addition to question recommendations, the recommendation engine may also recommend other types of pre-existing content, such as templates, etc.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A system, comprising:
a repository of survey pre-existing content connected to a network, wherein the pre-existing content has identifiable characteristics;
a first computer connected to the network to provide a user interface to allow access to survey creation tools connected to the repository;
a second computer connected to the network upon which resides the survey creation tools;
user information stored on one of the computers; and
a processor configured to:
allowing the user to create a survey using the user interface;
access the repository to retrieve the pre-existing content based upon the user information and the identifiable characteristics; and
offer the pre-existing content retrieved from the repository to the user through the user interface.

2. The system of claim 1, wherein the repository of survey of pre-existing content resides on one of the computers connected to the network.

3. The system of claim 1, wherein the repository, the first computer and the second computer all reside on one computing device.

4. The system of claim 1, wherein the processor resides in the second computer.

5. The system of claim 1, wherein the first computer comprises a portable device.

6. A computer-controlled method of recommending survey content to a user, comprising:
receiving an input from a user through a user interface that initiates creation of a survey;
accessing information about the user;
retrieving pre-existing content from a content repository based upon the information; and
presenting the pre-existing content to the user.

7. The computer-controlled method of claim 6, further comprising:
receiving an input from the user selecting an item of the pre-existing content;
updating the information about the user;
retrieving more pre-existing content from the question repository based upon the updated user information; and
presenting the pre-existing content to the user.

8. The computer-controlled method of claim 6, wherein the information about the user comprises one of a user profile, a survey category, a user location, from where the user came, browser information, operating system information, and a combination of these.

9. The computer-controlled method of claim 6, wherein the pre-existing content have identifiable characteristics.

10. The computer-controlled method of claim 6, wherein the identifiable characteristics relate to the user information.

11. The computer-controlled method of claim 6, wherein the method further comprises a self-leaning process.
